(19) United States
(12) Patent Application Publication
(10) Pub. No.: US 2025/0043145 A1
(43) Pub. Date: Feb. 6, 2025

(54) COMPOSITIONS AND METHODS OF USING MALEATED FATTY AMIDES OF POLYETHERAMINES FOR CORROSION INHIBITION

(71) Applicant: ChampionX LLC, Sugar Land, TX (US)

(72) Inventors: Jing Wu, Missouri City, TX (US); Shelley Zhou, Sugar Land, TX (US); Jeremy Moloney, Katy, TX (US)

(21) Appl. No.: 18/790,743

(22) Filed: Jul. 31, 2024

Related U.S. Application Data
(60) Provisional application No. 63/516,721, filed on Jul. 31, 2023.

(51) Int. Cl. C09D 171/02; C08G 65/332; C09D 5/08; C09D 7/20; C23F 11/173

(52) U.S. Cl. CPC C09D 171/02; C08G 65/3328; C09D 5/08; C09D 7/20; C23F 11/173

(57) ABSTRACT

Compositions for corrosion inhibitions, methods of making a chemically modified, maleated unsaturated fatty acids and salts thereof corrosion inhibitor, and methods of using the same are disclosed to provide alternatives for corrosion inhibition under harsh conditions with improved performance.

### CROSS REFERENCE TO RELATED APPLICATIONS

This application claims priority under 35 U.S.C. § 119 to provisional patent application U.S. Ser. No. 63/516,721, filed Jul. 31, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to corrosion-inhibiting compositions and methods for improved corrosion inhibition of metal surfaces in oil and gas application using chemically modified, maleated unsaturated fatty acids and salts thereof and corrosion-inhibiting compositions comprising the same to replace conventional corrosion inhibitors and provide alternatives for corrosion inhibition under harsh conditions with improved performance.

### BACKGROUND

Corrosion remains a significant challenge in the oil and gas industry and are most often caused by salts and/or other dissolved solids, liquids, or gases that cause, accelerate, or promote corrosion of surfaces such as metal surfaces. Controlling internal corrosion is a key problem encountered in flowlines and pipelines made from metal, namely carbon steel. Examples of corrodents include carbon dioxide, oxygen, sodium chloride, calcium chloride, and sulfur dioxide. Corrosion negatively impacts metal containments such as metal pipelines, tanks, and/or other metal equipment or devices that contact aqueous liquid sources before, during, or after injection or production.

Most operators in the oil and gas extraction and processing industry employ corrosion inhibitors to reduce internal corrosion in metal containments which are contacted by aqueous liquids containing corrodents. Corrodents are found in injectates, produced water, connate (native water present in subterranean formations along with the hydrocarbon), and hydrocarbon liquids and solids. Corrosion inhibitors are added to the liquids and dissolved gases which come into contact with metal surfaces where they act to prevent, retard, delay, reverse, and/or otherwise inhibit the corrosion of metal surfaces such as carbon-steel metal surfaces. Corrosion inhibitors can include, for example, aliphatic and aromatic amines, amine salts of acids, heterocyclic amines, alkenyl succinic acid, triazoles, and the like.

Corrosion inhibitors are beneficial in that they extend the lifespan of metal surfaces, as well as permit the use of carbon steel components rather than more expensive metals, such as nickel, cobalt, and chromium alloys or other materials more expensive than carbon steel and/or which inherently entail other disadvantages in suitability for the purpose of liquid or gas containment.

It is an object of this disclosure to provide chemically modified, maleated unsaturated fatty acid or salt thereof-based corrosion inhibitors, compositions including the same, and methods for corrosion inhibition of metal surfaces that improve beyond the corrosion inhibition capability of existing corrosion inhibitors.

It is a particular object of the disclosure to provide the chemically modified, maleated unsaturated fatty acids and salts thereof-based corrosion inhibition products to provide improved performance of corrosion inhibitors in hard conditions, including high shear stress, high temperature and high water cuts.

Other objects, embodiments advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide compositions and methods for inhibiting corrosion in oilfield systems, namely pipelines, containing oxygen.

According to some aspects of the present disclosure, corrosion-inhibiting compositions comprise chemically modified, maleated unsaturated fatty acid or salt thereof, wherein the chemical modification is an amidation of the maleated unsaturated fatty acids using a monoamine, and at least one of a solvent, additional corrosion inhibitor, asphaltene inhibitor, paraffin inhibitor, scale inhibitor, emulsion breaker, or combinations thereof.

According to a further aspect of the present disclosure, method of making a chemically modified maleated unsaturated fatty acid or salt thereof comprising chemically modifying a maleated unsaturated fatty acid or salt thereof as described herein, produced by an amidation reaction of the maleated unsaturated fatty acids using a polyether monoamine.

According to a further aspect of the present disclosure, methods of controlling corrosion on a surface comprise: providing a corrosive inhibiting effective amount of a corrosion inhibition composition as described herein into contact with a surface comprising metal and is in an oil-and-gas system, and wherein the contacting is added in a batch or continuous application, and reducing corrosion on the surface.

According to a further aspect of the present disclosure, treated metal containments comprise: a metal containment comprising a metal surface; and a barrier or film substantially coating the metal surface with a corrosive inhibiting effective amount of the compositions as described herein comprising the chemically modified, maleated unsaturated fatty acids or salts thereof.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION

The present disclosure is not to be limited to that described herein, which can vary and are understood by skilled artisans. No features shown or described are essential to permit basic operation of the present disclosure unless otherwise indicated. It has been beneficially found that various chemically modified, maleated unsaturated fatty acids and salts thereof and corrosion-inhibiting compositions comprising the same provide effective corrosion inhibition and are more environmentally acceptable compositions.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and urcido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (cpisulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

As used herein, the term “between” is inclusive of any endpoints noted relative to a described range.

As used herein, the term “containment” or “metal containment” includes any metal surface or portion thereof that is in contact with liquids in an oil-field system containing corrodent(s). In embodiments the containment is in fluid communication with one or more devices or apparatuses, including other containments. In embodiments the containment is a pipe. In embodiments the containment is a tank. In embodiments, the metal is steel. In embodiments, the steel is carbon steel. In embodiments, the carbon steel is stainless steel.

As used herein, the term “corrodent” refers to one or more salts and/or other dissolved solids, liquids, or gasses that cause, accelerate, or promote corrosion. Non-limiting examples of corrodents are oxygen, hydrogen sulfide, hydrogen chloride, carbon dioxide, sodium chloride, calcium chloride, sulfur dioxide, and combinations thereof. In exemplary embodiments, corrodents are capable of corroding a carbon steel at a rate of at least about 100 milli-inches per year (mpy).

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

The term “inhibiting” as referred to herein includes both inhibiting and preventing corrosion on a surface or within a system, namely an oil-field system.

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “produced water” means a water source that flows from a subterranean formation in a hydrocarbon recovery process such as hydraulic fracturing or tertiary oil recovery, further wherein the water source includes one or more hydrocarbons, one or more dissolved solids, or a combination thereof.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo(fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. Further, an alkylene group in the chain can be replaced with an ether, an amine, an amide, a carbonyl, an ester, a cycloalkyl, or a heterocyclo functional group. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Corrosion-Inhibiting Compositions

According to embodiments, the corrosion-inhibiting compositions include a chemically modified, maleated unsaturated fatty acid or salt thereof, wherein the chemical modification is an amidation of the maleated unsaturated fatty acids using a monoamine, and at least one of a solvent, additional corrosion inhibitor, asphaltene inhibitor, paraffin inhibitor, scale inhibitor, emulsion breaker, or combinations thereof. Additional functional ingredients can be included in the compositions as described herein.

The maleated unsaturated fatty acids is a maleated tall oil fatty acid having one or more of the following structures (wherein CAS #68139-89-9 represents a blend of the structures I, II, III):

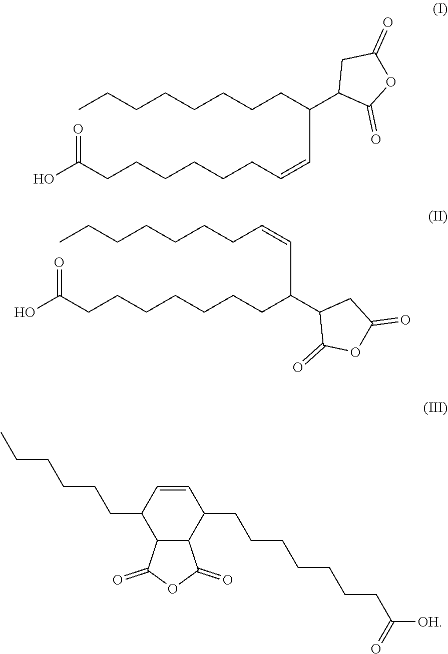 [SMILES: CCCCCCCCC(/C=C\CCCCCCC(=O)O)C1CC(=O)OC1=O ; CCCCCCC/C=C\C(CCCCCCCC(=O)O)C1CC(=O)OC1=O ; CCCCCCC1C=CC(CCCCCCCC(=O)O)C2C(=O)OC(=O)C12]

Notably the maleated unsaturated fatty acids, including the preferred maleated tall oil fatty acid does not include “oxidized and maleated” compounds, or oxmal compounds, such as oxidized and maleated tall oil compounds. As referred to herein oxmal compounds are those that have maleated and oxidized, such as those disclosed in U.S. Pat. No. 8,334,363. The exclusion of such oxidized and maleated compounds from the methods for making the chemically modified, maleated unsaturated fatty acid or salt thereof ensures that the resultant compounds are sufficiently hydrophilic to provide desired water partitioning, unlike the result that would be obtained through use of the hydrophobic reagents of these oxidized and maleated tall oil fatty acids which result in bad water partitioning.

The chemically modified, maleated unsaturated fatty acid or salt thereof, has a chemical modification that is an amidation of the maleated unsaturated fatty acids using a monoamine. As referred to herein, the monoamine is a polyether monoamine having the general structure:

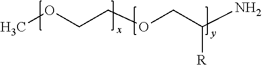

wherein R is hydrogen (H for EO) or methyl (CH₃ for PO), x and y are independently integers from about 1 to about 150, or from about 1 to about 50, or from about 1 to about 25. Polyether monoamines contain a primary amino group attached to the terminus of a polyether backbone, which can be based either on propylene oxide (PO), ethylene oxide (EO), or mixed EO/PO. In embodiments, the monoamine is a polyether monoamine having a molecular weight from about 200 to about 2000 g/mol. Commercially available examples of the polyether monoamines include Jeffamine-M branded monoamines having varying PO/EO mol ratios and MW.

Without being limited to a particular mechanism of action, the use of polyether monoamines instead of other monoamines, such as an alkanolamine or an ethoxylated amine, is favored based on increased number of EO groups to improve the water partitioning of compound for use in the corrosion-inhibiting compositions. In addition, the resulting chemically modified, maleated unsaturated fatty acid or salt thereof, the fatty amides, fatty acids and EO groups are multifunctional groups further improving water partitioning of products, while also controlling corrosion.

The resulting chemically modified, maleated unsaturated fatty acid or salt thereof is an amide having at least one acyl group linked to the nitrogen atom from the amidation of the monoamine. The resulting chemically modified, maleated unsaturated fatty acid or salt thereof has one or more of the following structures (Ia, Ib, Ic, IIa, IIb, IIc, IIIa, IIIb, IIIc), or preferably a blend of the following structures:

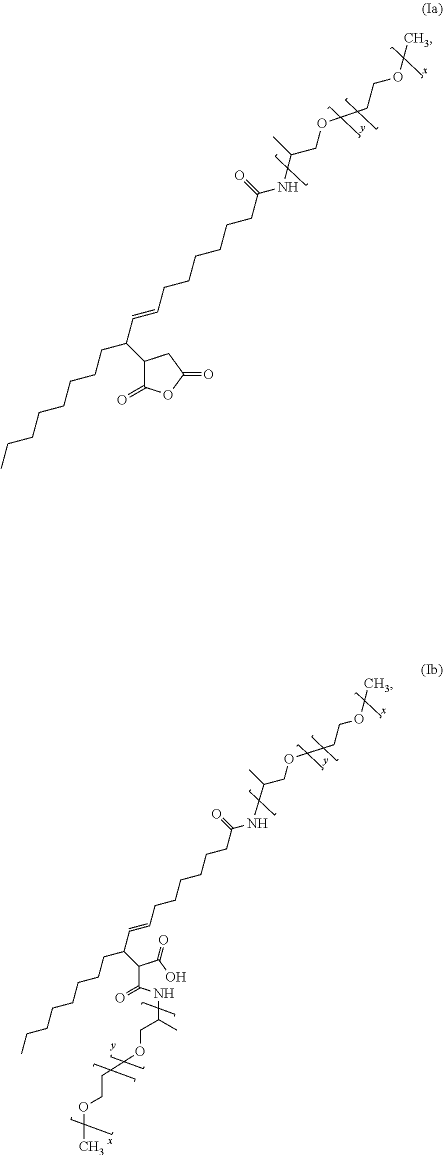

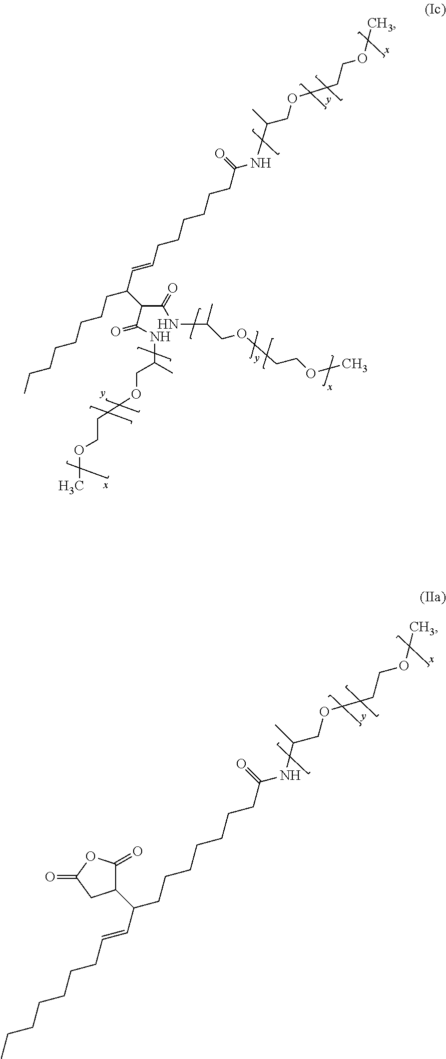

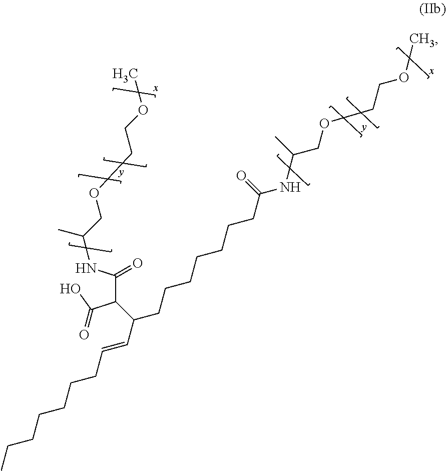

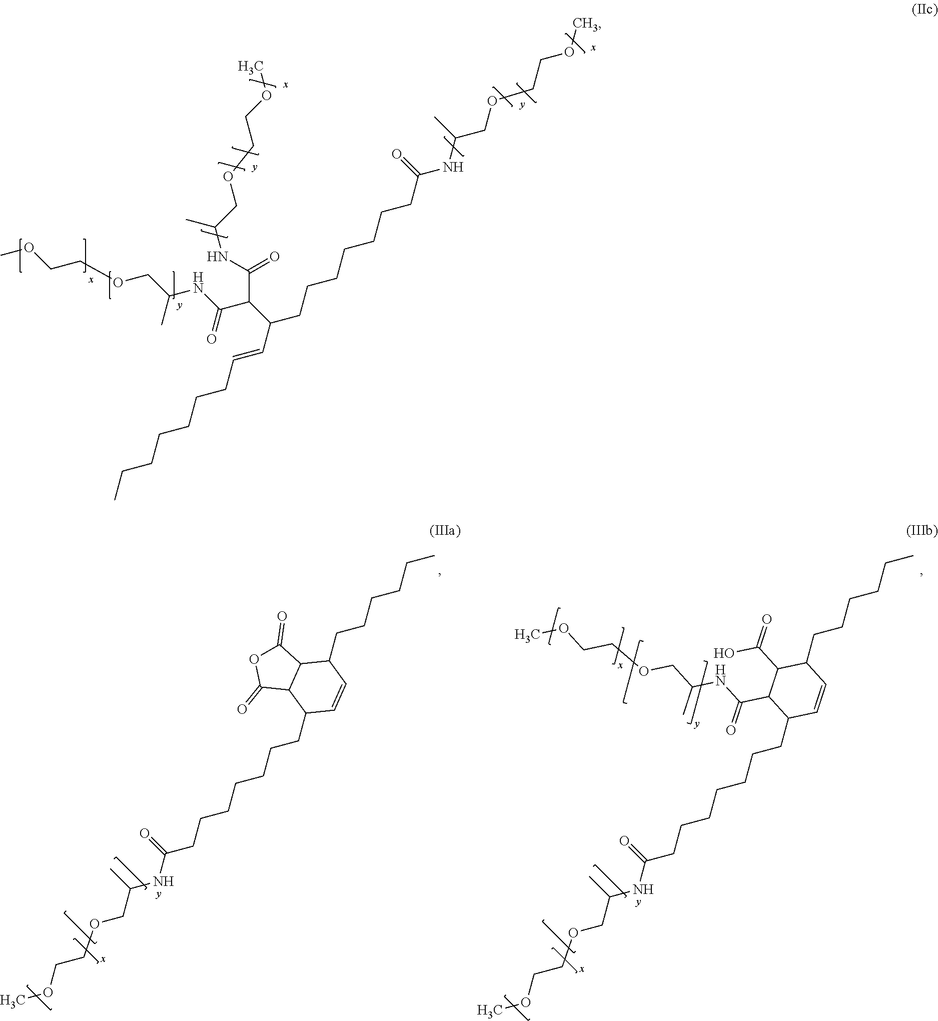

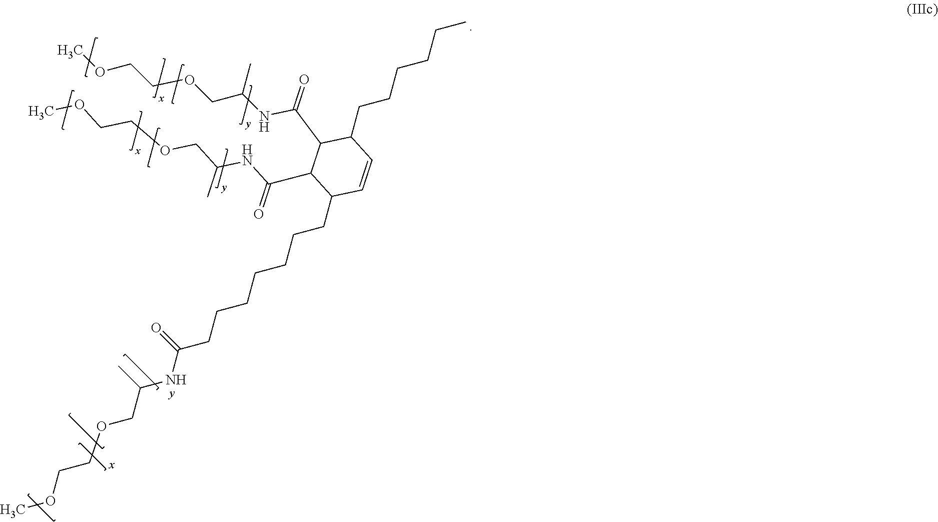

In preferred embodiments the chemically modified, maleated unsaturated fatty acid or salt thereof has an amine value greater than zero mgKOH/g, including for example, between about 1 mgKOH/g and about 10 mgKOH/g amine value, or between about 5 mgKOH/g and about 10 mgKOH/g amine value.

In preferred embodiments the chemically modified, maleated unsaturated fatty acid or salt thereof has an acid value less than 50 mgKOH/g, including for example, less than about 20 mgKOH/g, or less than about 15 mgKOH/g acid value.

In further preferred embodiments the chemically modified, maleated unsaturated fatty acid or salt thereof has an amine value greater than zero mgKOH/g and an acid value less than 50 mgKOH/g, wherein the acid number is greater than the total amine value. Without being limited to a particular mechanism of action, the chemically modified, maleated unsaturated fatty acid or salt thereof having the described acid numbers and total amine values result from the opened maleic anhydride group in the compound contributing two carboxylic acid groups which in various embodiments are not reacted with the monoamine, providing the improved corrosion inhibition and water partitioning.

In some embodiments the chemically modified, maleated unsaturated fatty acid or salt thereof retains at least one unreacted carboxylic acid group (structures Ia, Ib, IIa, IIb, IIIa, IIIb). In other embodiments the chemically modified, maleated unsaturated fatty acid or salt thereof retains one unreacted carboxylic acid group (structures Ib, IIb, IIIb).

The modification of the maleated unsaturated fatty acid or salt thereof with a monoamine results in different compounds from those chemically modified with a polyamine. For example, U.S. Publication No. 2009/0065736 uses various polyamines for modification, including for example, diethylenetriamine, triethylenetetramine, polylysine, various polyamine Jeffamines®, dipropylenetriamine, triproplyenetetraamine, 1,2-bis(3-aminopropylamino) ethane, bis(hexamethylene)triamine, 1,3-propanediamine, and biogenic polyamines. Even small polyamines such as ethylenediamine crosslink two hydrocarbon chains through the amidation of the maleated unsaturated fatty acid. These types of chemical modifications of the maleated unsaturated fatty acid result in cross-linking in the amidation reaction product, unlike the use of a monoamine with a single amine group that is unable to crosslink the two hydrocarbon chains. Such cross-linked amidation products using a polyamine cross link between the maleated fatty acid molecules, resulting in chemically modified, maleated unsaturated fatty acid or salt thereof with amine values of zero mgKOH/g and acids values that are greater than 50 mgKOH/g or even 50-300 mgKOH/g. These cross-linked products are undesirable compounds for corrosion inhibition as they do not provide desired water partitioning in use. Moreover, the modification of the maleated unsaturated fatty acid or salt thereof with a monoamine results in different compounds from those chemically modified with a polyamine to provide oxidized and maleated compounds. For example, U.S. Pat. No. 8,133,970 also provides cross-linked hydrocarbon chains through a bridging group. Bridging groups such as a direct bond, an ether linkage, or a peroxide linkage in the oxidized and maleated compounds result in undesirable compounds for corrosion inhibition as they do not provide desired water partitioning in use as achieved by the chemically modified, maleated unsaturated fatty acid or salt thereof as demonstrated in the Examples herein.

In some embodiments, the chemically modified, maleated unsaturated fatty acid or salt thereof corrosion inhibitor is included in the corrosion-inhibiting composition at an amount of at least about 1 wt-% to about 70 wt-%, about 1 wt-% to about 60 wt-%, about 10 wt-% to about 60 wt-%, about 10 wt-% to about 50 wt-%, about 10 wt-% to about 40 wt-%, or about 10 wt-% to about 30 wt-%. In addition, without being limited according to the disclosure, all ranges recited are inclusive of the numbers defining the range and include each integer within the defined range.

The chemically modified, maleated unsaturated fatty acid or salt thereof corrosion inhibitor can be made as a reaction product of a maleated unsaturated fatty acids and a monoamine. The methods of making the chemically modified, maleated unsaturated fatty acid or salt thereof corrosion inhibitor include desired temperature ranges for the monoamine and maleated fatty acid reaction as well as the relative mole ratio of the monoamine and carboxyl groups for reaction between the monoamine and the maleated fatty acid composition.

In an embodiment, the amidation reaction is conducted at a temperature between about 50° C. and about 200° C. which is sufficient to cause reaction between the amine groups of the monoamine and a carboxyl moiety of the fatty acid. In further embodiments, the temperature is between about 100° C. and about 200° C., or about 150° C. and about 200° C. In embodiments the amidation reaction takes place with a molar ratio of the monoamine to the maleated unsaturated fatty acid from about 0.1:1 to about 1:0.1, from about 0.5:1 to about 1:0.5, or about 1:1.

### Solvent

The chemically modified, maleated unsaturated fatty acid or salt thereof corrosion inhibitors can be generated with, combined with or delivered with a solvent. In some embodiments at least one solvent is included in the composition. Exemplary solvents include water, organic solvents and/or aromatic solvents.

Further exemplary organic solvents can include an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, glycols and derivatives (ethylene glycol, methylene glycol, 1,2-propylene glycol, 1,3-propylene glycol, diethyleneglycol monomethyl ether, ethylene glycol monobutyl ether, ethylene glycol dibutyl ether, etc.), pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

In some embodiments, an alcohol solvent is used, including straight chain or branched aliphatic such as methanol, ethanol, propanol, isopropanol, butanol, 2-ethylhexanol, hexanol, octanol, decanol, 2-butoxyethanol, etc.

In some embodiments, the composition comprises one or more solvents selected from the group consisting of isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, aromatic solvents, or any combination thereof.

Exemplary aromatic solvents comprise aromatic hydrocarbons such as toluene, xylene, heavy aromatic naphtha, C9-C11 aromatic hydrocarbons (Aromatic 150 or Aromatic Solvent C10) or a combination thereof. Preferably, the aromatic solvent comprises heavy aromatic naphtha or xylene. In any of the embodiments described the aromatic solvent(s) is preferably combined with water.

As one skilled in the art will ascertain from the disclosure herein, the solvents employed in the methods of chemically modifying a maleated unsaturated fatty acid or salt thereof as described herein through an amidation reaction of the maleated unsaturated fatty acids with the monoamine are high boiling solvent(s) that do not react with the reagents and are able to be used in high temperature applications. Various aromatic solvents are particularly suitable for the methods of chemically modifying a maleated unsaturated fatty acid or salt thereof as described herein, e.g. C9-C11 aromatic hydrocarbons (Aromatic 150 or Aromatic Solvent C10).

In some embodiments, the solvent(s) is included in a composition with the chemically modified, maleated unsaturated fatty acid or salt thereof corrosion inhibitors at an amount of at least about 20 wt-% to about 99 wt-%, about 30 wt-% to about 99 wt-%, about 40 wt-% to about 99 wt-%, about 45 wt-% to about 90 wt-%, or about 50 wt-% to about 90 wt-%. In addition, without being limited according to the disclosure, all ranges recited are inclusive of the numbers defining the range and include each integer within the defined range.

### Additional Functional Ingredients

The components of the corrosion-inhibiting composition can further be combined with various functional components suitable for uses disclosed herein. In some embodiments, the corrosion-inhibiting compositions including the chemically modified, maleated unsaturated fatty acid or salt thereof and at least one solvent or additional functional ingredient make up a large amount, or even substantially all of the total weight of the compositions. In some embodiments, the corrosion-inhibiting compositions including the chemically modified, maleated unsaturated fatty acid or salt thereof and at least one solvent, synergist, additional corrosion inhibitor, asphaltene inhibitor, paraffin inhibitor, scale inhibitor, emulsion breaker, or combinations thereof make up a large amount, or even substantially all of the total weight of the compositions. For example, in some embodiments few or no additional functional ingredients are disposed therein.

In other embodiments, additional functional ingredients may be included in the corrosion-inhibiting compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the compositions may include synergist, additional corrosion inhibitors, solvents, pH modifiers, surfactants, hydrate inhibitors, scale inhibitors, biocides, salt substitutes, relative permeability modifiers, sulfide scavengers, breakers, asphaltene inhibitors, paraffin inhibitors, metal complexing agents (chelants), emulsifiers, demulsifiers, iron control agents, friction reducers, drag reducing agents, flow improvers, viscosity reducers, and the like. Exemplary types of the various additional functional ingredients is included in U.S. Pat. No. 11,242,480, which is incorporated by reference in its disclosure of the various listings of additional functional ingredients.

According to embodiments of the disclosure, the combination of any additional functional ingredients may be provided in a composition in the amount from about 0 wt-% and about 90 wt-%, from about 5 wt-% and about 90 wt-%, or from about 10 wt-% and about 90 wt-%. In addition, without being limited according to the disclosure, all ranges recited are inclusive of the numbers defining the range and include each integer within the defined range.

### Synergist

The chemically modified, maleated unsaturated fatty acid or salt thereof corrosion inhibitors can be combined with or delivered with a synergist. An exemplary synergist class includes mercaptan corrosion inhibitors. Mercaptans are a type of organic thiol molecules and can create a stronger passivation layer on the metal surface to increase persistency of the protective film for corrosion inhibition. In most examples, the sulfur based component consists of a primary thio/mercaptan (e.g., 2-mercaptoethanol or mercaptoacetic acid). Mercaptans are a type of organic sulfur compounds, which include mercaptoalkyl alcohol, mercaptoacetic acid, tert-butyl mercaptan, or a combination thereof. A preferred synergist is a mercaptoalkyl alcohol comprising 2-mercaptoethanol.

Additional exemplary synergist class includes amines such as thiol-amines as disclosed in U.S. Pat. No. 11,242,480, which is incorporated herein by reference in its entirety. These thiol-amines include a class of anti-corrosion compounds having the formula:

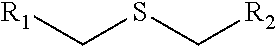

wherein: each R₁ is independently —CH₂OH and —C(O)OH; and R₂ is

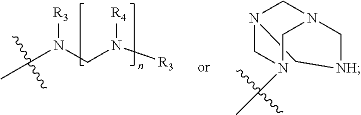

Each R₃ is independently hydrogen or R₅, or both R₃ together form a ring via linker having the formula

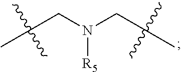

Each R₄ is independently hydrogen or R₅; R₅ is-CH₂SC₂H₅R₁; and n is an integer from 0 to 3.

In some embodiments, the synergist is included in a composition with the corrosion inhibitors at an amount of at least about 0.1 wt-% to about 20 wt-%, about 1 wt-% to about 20 wt-%, about 5 wt-% to about 20 wt-%, about 5 wt-% to about 15 wt-%, or about 5 wt-% to about 10 wt-%. In addition, without being limited according to the disclosure, all ranges recited are inclusive of the numbers defining the range and include each integer within the defined range.

### Methods of Use

The chemically modified, maleated unsaturated fatty acid or salt thereof corrosion inhibitors or the corrosion-inhibiting compositions are provided to a system in need of effective corrosion control. The methods are suitable for controlling both general and localized corrosion as well as reducing pitting on surfaces.

The chemically modified, maleated unsaturated fatty acid or salt thereof corrosion inhibitors or the corrosion-inhibiting compositions can be provided in a single composition to an oil-field system or can be combined with other components, such as solvents, synergists, additional corrosion inhibitors, and the like. In referring to compositions, the scope of the methods of use disclosure also includes combining more than one input (i.e. composition) for the treatment of an oil-field system.

The methods of use include adding a corrosive inhibiting effective amount of a chemically modified, maleated unsaturated fatty acid or salt thereof corrosion inhibitor or the corrosion-inhibiting composition to an oil-field system having at least one surface and inhibiting corrosion of the at least one surface. Beneficially, the composition reduces corrosion of a surface compared to a corrosive environment that does not contain the chemically modified, maleated unsaturated fatty acid or salt thereof corrosion inhibitor. In embodiments, the corrosion reduction (i.e. inhibition efficiency) is at least about 70%, at least about 80%, at least about 90%, or at least about 95% for a surface comprising metal.

The methods apply the chemically modified, maleated unsaturated fatty acid or salt thereof corrosion inhibitors or the corrosion-inhibiting compositions to a system in need of preventing, reducing or mitigating corrosion. Beneficially, for the corrosion inhibition both localized and generalized corrosion are reduced, as measured by mils penetration per year or milli-inch (one thousandth of an inch) (MPY). MPY is used as an estimated general corrosion rate. The MPY is calculated from the following equation:

$$MPY = ( Δ M [ g ] \cdot C ) / ( ρ [ \frac{g}{{cm}^{2}} ] \cdot A [ {in}^{2} ] \cdot t [ hr ] )$$

where ΔM is the mass loss of the coupon at the end of the test in grams, C is a constant equal to 534000, p is the density of the coupon in g/cm², A is the surface area of the coupon in cm², and t is the exposure time in hours.

The method comprises adding the chemically modified, maleated unsaturated fatty acid or salt thereof corrosion inhibitors or the corrosion-inhibiting compositions in a corrosive inhibiting effective amount. The dosage amounts of the compositions described herein to be added to oil-field system can be tailored by one skilled in the art based on factors for each system, including, for example, content of fluid, volume of the fluid, surface area of the system, temperatures, pH, and CO₂ content. In embodiments, an effective amount of the composition is from about 1 ppm to about 5000 ppm, based on the total volume of the system. In embodiments, an effective amount of the composition is from about from about 10 ppm to about 1000 ppm, based on the total volume of the system.

The oil-field systems include oil or gas pipelines and refineries, including for example, well, pipeline, fuel storage and/or transportation tanks, fuel distribution system.

The system includes a fluid to which the composition is added. A fluid to which the compositions can be introduced can be a hydrocarbon fluid or gas, produced water, or combination thereof. As referred to herein, hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof. In many embodiments, hydrocarbon fluids comprise refined hydrocarbon product. The liquid can also be a heavy brine.

The fluid can be contained in and/or exposed to many different types of apparatuses. In embodiments, the fluid is contained in a containment, such as an oil or gas pipeline. Additionally, the fluid can be contained in refineries, such as surfaces used in the recovery, transportation, refining and/or storage of hydrocarbon fluids or gases.

In embodiments, treated metal containments are provided with the methods described herein. In embodiments a metal containment comprises a metal surface and a barrier or film substantially coating the metal surface with a corrosive inhibiting effective amount of the compositions (or the chemically modified maleated unsaturated fatty acid or salt thereof corrosion inhibitors described herein). In embodiments, the corrosive inhibiting effective amount of the chemically modified, maleated unsaturated fatty acids and salts thereof is from about 1 ppm to about 5000 ppm, or from about 10 ppm to about 1000 ppm, based on the total volume of the containment.

The oil-field systems comprise a surface in need of corrosion inhibition. Exemplary surfaces can include separation vessels, dehydration units, gas lines, oil and/or gas pipelines, or other part of an oil and/or gas refinery. Similarly, the fluid can be contained in and/or exposed to an apparatus used in oil extraction and/or production, such as a wellhead. The apparatus can be part of a coal-fired power plant. The apparatus can be a scrubber (e.g., a wet flue gas desulfurizer, a spray dry absorber, a dry sorbent injector, a spray tower, a contact or bubble tower, or the like). The apparatus can be a cargo vessel, a storage vessel, a holding tank, or a pipeline connecting the tanks, vessels, or processing units.

The system comprises a metal surface subject to corrosion. In embodiments the surfaces can include a variety of metal surfaces that are subject to corrosion. The metals can comprise a component selected from the group consisting of mild steel, galvanized steel, carbon steel, aluminum, aluminum alloys, copper, copper nickel alloys, copper zinc alloys, brass, chrome steels, ferritic alloy steels, austenitic stainless steels, precipitation-hardened stainless steels, high nickel content steels, and any combination thereof.

The compositions are particularly well suited for corrosion inhibition in harsh conditions, including temperatures, flow line conditions (e.g. low and high shear stress), high water cut, and the like.

The compositions are applied to fluids in an oil-field system at varying pH ranges. In an embodiment the pH of the fluids will be between about 5 and about 9.

The compositions can be applied to a fluid in an oil-field system at any selected temperature, such as ambient temperature or an elevated temperature. The fluid (e.g., liquid hydrocarbon) can be at a temperature of from about 0° C. to about 300° C.

The compositions can be applied to a fluid in both high and low shear systems. In an embodiment the compositions are applied to a fluid with less than about 10 pa (low shear) or greater than about 50 pa (high shear), which are also inclusive of moderate shear in between these ranges.

The compositions can be added to a fluid at various levels of water cut. For example, the water cut can be from 0% to 100% volume/volume (v/v), from 1% to 80% v/v, or from 1% to 60% v/v. In embodiments the compositions beneficially provide corrosion inhibition in high water cut systems, such as great than about 20% volume/volume water cut.

The compositions can be applied by any appropriate method for ensuring dispersal through the fluid. The compositions can be applied to a fluid using various well-known methods and they can be applied at numerous different locations throughout a given system. For example, the compositions can be injected using mechanical equipment such as chemical injection pumps, piping tees, injection fittings, atomizers, quills, and the like. The compositions can be pumped into an oil and/or gas pipeline using an umbilical line. A capillary injection system can be used to deliver the compounds/compositions to a selected fluid.

The compositions can be added to the system manually or automatically in either a batch or continuous manner to provide the effective amount of the corrosion-inhibiting composition. In some embodiments, the compositions are added to a flow line to provide a corrosive inhibiting effective amount from about 1 to about 5000 parts per million (ppm), about 1 ppm to about 1000 ppm, or about 10 ppm to about 1000 ppm, based on the total volume of the system. In some embodiments, the compositions are added to a flow line to provide a corrosive inhibiting effective amount from at least about 1 ppm, 2 ppm, 5 ppm, 10 ppm, 20 ppm, 50 ppm, 100 ppm, 200 ppm, 250 ppm, or 500 ppm based on the total volume of the system. Each system can have its own dose level requirements, and the effective dose level of the composition to sufficiently reduce the rate of corrosion can vary with the system in which it is used.

The compositions can be added to the system by any suitable means, including for example by injecting the composition into a fluid or gas in contact with the metal surface, pumping the composition onto the metal surface, pouring the composition onto the metal surface, spraying the composition onto the metal surface, wiping the metal surface with the composition, coating the metal surface with the composition, dipping the metal surface in the composition, soaking the metal surface in the composition, or any combination thereof.

### EMBODIMENTS

The present disclosure is further defined by the following numbered embodiments:
1. A corrosion-inhibiting composition comprising: chemically modified, maleated unsaturated fatty acid or salt thereof, wherein the chemical modification is an amidation of the maleated unsaturated fatty acids using a monoamine, and at least one of a solvent, synergist, additional corrosion inhibitor, asphaltene inhibitor, paraffin inhibitor, scale inhibitor, emulsion breaker, or combinations thereof.
2. The composition of embodiment 1, wherein the monoamine is a polyether monoamine having the general structure:

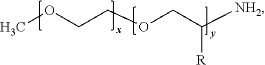

wherein R is H or CH₃, x and y are independently integers from about 1 to about 150.
3. The composition of any one of embodiments 1-2, wherein the monoamine is a polyether monoamine having a molecular weight from about 200 to about 2000 g/mol.
4. The composition of any one of embodiments 1-3, wherein the maleated unsaturated fatty acid is a maleated tall oil fatty acid having one or more of the following structures: (I), (II), (III).
5. The composition of any one of embodiments 1-4, wherein the chemically modified, maleated unsaturated fatty acid or salt thereof have one or more of the following general structures, or preferably a blend of the following structures: (Ia), (Ib), (Ic), (IIa), (IIb), (IIc), (IIIa), (IIIb), (IIIc).
6. The composition of any one of embodiments 1-5, wherein the chemically modified, maleated unsaturated fatty acid or salt thereof has a total amine value greater than zero mgKOH/g and/or an acid value less than 50 mgKOH/g.
7. The composition of embodiment 6, wherein the acid value is greater than the total amine value.
8. The composition of any one of embodiments 5-7, wherein the chemically modified, maleated unsaturated fatty acid or salt thereof has one or more of the structures Ia, Ib, IIa, IIb, IIIa, and/or IIIb, or one or more of the structures Ib, IIb, and/or IIIb.
9. The composition of any one of embodiments 1-8, wherein the solvent comprises ethylene glycol monobutyl ether and/or aromatic solvents.
10. The composition of any one of embodiments 1-9, wherein the corrosion inhibition composition further comprises at least one additional component selected from the group consisting of synergist, additional corrosion inhibitors, surfactants, polymers, pH modifiers, asphaltene inhibitors, paraffin inhibitors, scale inhibitors, metal complexing agents (chelants), emulsifiers, water clarifiers, dispersants, emulsion breakers and combinations thereof.
11. The composition of any one of embodiments 1-11, wherein the chemically modified, maleated unsaturated fatty acid or salt thereof makes up from about 1 wt-% to about 50 wt-% of the composition, wherein the solvent(s) make up from about 40 wt-% to about 99 wt-% of the composition.
12. A method of making a chemically modified maleated unsaturated fatty acid or salt thereof comprising: chemically modifying a maleated unsaturated fatty acid or salt thereof according to any one of embodiments 1-11, produced by an amidation reaction of the maleated unsaturated fatty acids using a polyether monoamine.
13. The method of embodiment 12, wherein the amidation reaction temperature is between about 50° C. and about 200° C.
14. The method of any one of embodiments 12-13, wherein the molar ratio of the polyether monoamine to the maleated unsaturated fatty acid is from about 0.1:1 to about 1:0.1.
15. A method of controlling corrosion on a surface comprising: providing a corrosive inhibiting effective amount of a corrosion inhibition composition according to any one of embodiments 1-11, or a chemically modified maleated unsaturated fatty acid or salt thereof produced by the process of any one of embodiments 12-14, into contact with a surface comprising metal in an oil-and-gas system, and wherein the contacting is added in a batch or continuous application, and reducing corrosion on the surface.
16. The method of embodiment 15, wherein the corrosive inhibiting effective amount of the composition is from about 1 ppm to about 5,000 ppm, based on the total volume of the system.
17. The method of any one of embodiments 15-16, wherein the metal surface comprises steel.
18. The method of embodiment 17, wherein the surface is a containment used in the production, transportation, storage and/or separation of crude oil, natural gas or a biofuel process.
19. The method of any one of embodiments 15-18, wherein the system comprises a hydrocarbon fluid or gas, produced water, or combination thereof.
20. A treated metal containment comprising: a metal containment comprising a metal surface; and a barrier or film substantially coating the metal surface with a corrosive inhibiting effective amount of the composition according to any one of embodiments 1-11 comprising the chemically modified, maleated unsaturated fatty acids or salts thereof.
21. The treated metal containment of embodiment 20, wherein the corrosive inhibiting effective amount of the chemically modified, maleated unsaturated fatty acids and salts thereof is from about 1 ppm to about 5000 ppm, or from about 10 ppm to about 1000 ppm, based on the total volume of the containment.
22. The treated metal containment of any one of embodiments 20-21, wherein the metal surface comprises steel.
23. The treated metal containment of any one of embodiments 20-22, wherein the surface is a containment used in the production, transportation, storage and/or separation of crude oil, natural gas or a biofuel process.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Synthesizing the Chemically Modified, Maleated Unsaturated Fatty Acid or Salt Thereof

A chemically modified, maleated unsaturated fatty acid or salt thereof was made as a reaction product of a maleated unsaturated tall fatty acid (CAS #68139-89-9 from Ingevity Tenax 2010, corresponding to structures (I, II, III) and the polyether monoamine Jeffamine M-1000 in solvents. The corrosion inhibitor was prepared in a 500 mL flask with overhead stirrer, thermal control and condenser. 35.40 grams of maleated tall oil fatty acid, 101.2 grams of Aromatic 150 solvent, and 168.64 grams of Jeffamine M-1000 were loaded while mixing and heated to 150° C. and maintained at the temperature for 6 hours. This provided a reaction ratio of 4.8:1 Jeffamine to maleated tall oil fatty acid (TOFA) that provided approximately a 1:1 molar ratio of the reagents. After cooling, the total amine value of the product was 5.72 mgKOH/g and the acid value was 11.23 mgKOH/g. Ethylene glycol monobutyl ether was added to make the corrosion inhibitor at 50% activity.

In the making of the reaction product corrosion inhibitor, at combining the reagents and before heating up the Acid Number and Total Amine Value of mixture are same, at 31 mgKOH/g. After reaction, Total Amine Value of product mixture is 5.72 mgKOH/g and Acid number is 11.23 mgKOH/g and the product has the blend of structures Ia, Ib, Ic, IIa, IIb, IIc, IIIa, IIIb, IIIc.

Further heating and reaction would result in further reduced Acid Number and Amine Value with further reacted carboxylic acid groups on the corrosion inhibitor. The structures of the chemically modified, maleated unsaturated fatty acid or salt thereof are shown in structures Ia, Ib, IIa, IIb, IIIa, IIIb (with unreacted carboxylic acid groups).

### Example 2

Examples were conducted to assess the corrosion inhibitor produced in Example 1 using bubble cell tests to assess corrosion performance using linear polarization resistance testing. The corrosion inhibitor was combined with the sulfur synergist 2-mercaptoethanol.

The bubble test simulates low flow areas where little or no mixing of water and oil occurs. The test was conducted using synthetic brine (80% of the brine being 3% sodium chloride brine and 20% of the brine being a hydrocarbon containing LVT-200) as shown in Table 1.

TABLE 1

| Salt | Mass (g/L) |
|---|---|
| NaCl | 12.7518 |
| CH₃COONa | 3.3206 |
| Na₂SO₄ | 0.0503 |
| NaHCO₃ | 0.7242 |
| KCl | 0.1563 |
| CaCl₂•H₂O | 0.6749 |

The brine was placed into kettles and purged with carbon dioxide resulting in carbon dioxide saturated brine. The brine was continually purged with carbon dioxide at 1 bar CO₂ to saturate the brine prior to starting the test for a 2 hour pre-corrode. After the test began, the test cell was blanketed with carbon dioxide one hour prior to electrode insertion and through the duration of the test to maintain saturation. The kettles were stirred at 100 revolutions per minute (rpm) for the duration of the test at 66° C.

The corrosion rate was measured by Linear Polarization Resistance (LPR) techniques. The working electrode used was carbon steel (C1018 grade). The counter and reference electrodes were both 1018 carbon steel. The electrodes were all cleaned and polished prior to testing. Data were collected for 2 hours before 10 ppm of the corrosion inhibitor composition (containing 20% of the reaction product corrosion inhibitor) was added, equating to 2 ppm of the active reaction product corrosion inhibitor with 0.5 ppm 2-mercaptoethanol being introduced into the test cell. Data were collected overnight for 21 hour test duration. The results are summarized in Table 2.

TABLE 2

| | | | Candidate | 2- | | Corrosion | |
|---|---|---|---|---|---|---|---|
| | | | chemistry | mercaptoethanol | | rate after | |
| Candidate | 2- | CI | active | active | Avg. Blank | 22 hour CI | |
| chemistry | mercaptoethanol | Dosage | injected | injected | Corrosion | injection | % |
| active (%) | (%) | (ppm) | (ppm) | (ppm) | Rate (mpy) | (mpy) | Protection |
| 20 | 5 | 10 | 2 | 0.5 | 229.4 | 6.3 | 97.2 |

### Example 3

Further corrosion inhibition efficacy was evaluated with a Corrosion Buchi autoclave test performed with the following conditions to evaluate corrosion performance of the corrosion inhibitor produced in Example 1 on carbon steel coupons (X65 grade). The corrosion rate was calculated based on weight loss and the pit depth was obtained using Bruker Npflex Profilometer.

The test conditions included: 121° C., 100% pre-partitioned synthetic brine as described in Table 1, 16 psi CO₂, 100 psi N2,130 Pa shear stress, 7 days. After the tests, X-65 flat were cleaned for mass loss to calculate general corrosion rate and also scanned using the Bruker Npflex Profilometer to measure pit depth.

The pre-partition conditions included: 60° C., 40% synthetic brine as described in Table 1 and 60% hydrocarbon, 150 ppm of the evaluated corrosion inhibitor and synergist as described in Example 2, mixed at 500 rpm for 30 minutes, allowing separation prior to transferring brine to the autoclave.

Results of the Buchi autoclave testing are shown in Table 3.

TABLE 3

| CI | CI | | Corrosion Rate | Average pit depth |
|---|---|---|---|---|
| chemistry | activity | Dosage | after 7-day test | after 7-day test |
| tested | (%) | (ppm) | (mpy) | (μm) |
| Blank | N/A | N/A | 4.39 | 44 |
| Example 1 CI | 15 | 150 | 1.95 | 7 |

The results show the evaluated chemically modified, maleated unsaturated fatty acid or salt thereof provides corrosion inhibition efficacy. The compound reduced mpy as well as pit depth.

### Example 4

Additional corrosion inhibition efficacy was evaluated with a sour rotating cage autoclave (RCA) tests performed using following conditions to evaluate corrosion performance of the corrosion inhibitor produced in Example 1 on a carbon steel coupon (X65 grade). The corrosion rate was calculated based on weight loss and the pit depth was obtained using the Bruker Npflex Profilometer.

RCA test conditions included: 135° C., 90% synthetic brine (as described in Table 4), 40 psi CO₂, 0.32 psi H₂S, 16 Pa shear stress, for 7 days.

TABLE 4

| Salt | Mass (g/L) |
|---|---|
| NaCl | 181.6 |
| CH₃COONa | 0.1 |
| NaHCO₃ | 0.17 |
| KCl | 8.3 |
| NaBr | 1.2 |
| BaCl₂•2H₂O | 0.02 |
| SrCl₂•6H₂O | 3.6 |
| MgCl₂•6H₂O | 3.8 |
| CaCl₂•2H₂O | 100.7 |

After the tests, two X-65 flat coupons/per test were cleaned for mass loss to calculate general corrosion rate and then scanned using Bruker Npflex Profilometer for pit depth. Results of the RCA autoclave testing are shown in Table 5.

TABLE 5

| | | | Corrosion | Average |
|---|---|---|---|---|
| | Candidate | | Rate | Pit Depth |
| CI | Chemistry | | After 7- | After 7- |
| chemistry | Activity | Dosage | day Test | day Test |
| tested | (%) | (ppm) | (mpy) | (μm) |
| Blank | 0 | 0 | 19.81 | 50 |
| Example 1 | 15 | 600 | 2.95 | 6 |
| CI | | | | |

The results show the evaluated chemically modified, maleated unsaturated fatty acid or salt thereof provides corrosion inhibition efficacy under sour and high temperature conditions as well as high shear conditions.

The testing in Examples 2-4 does not show residual corrosion inhibitor data in the brine to demonstrate the improved partitioning of the chemically modified, maleated unsaturated fatty acid or salt thereof. However, the tests were completed using a brine separated from pre-partitioning stage as described in the methodology, where the corrosion inhibitor was added into brine and oil mixture and homogenized. The chemically modified, maleated unsaturated fatty acid or salt thereof provide an improved partitioning which is important for the corrosion inhibitor to be present in the water phase and reach the metal surface in need of corrosion inhibitor. In embodiments the corrosion inhibitors described herein provide improved partitioning between the oil, water and solid phases of fluid within a system or containment. Such methodology for further demonstration can include partitioning of the corrosion inhibitor using a modified standard LPR (Linear Polarization Resistance) corrosion test, followed by an analysis of the corrosion inhibitor residuals in the various phases using an LC-MS (Liquid Chromatography-Mass Spectroscopy) analytical method.

### Example 5

The chemically modified, maleated unsaturated fatty acid corrosion inhibitor produced in Example 1 was further compared to the maleated unsaturated tall oil fatty acid (CAS #68139-89-9 from Ingevity Tenax 2010, corresponding to structure (III)) to evaluate the corrosion inhibition performance using the using bubble cell tests as described in Example 2. The corrosion inhibitor was combined with the sulfur synergist 2-mercaptoethanol. The test was conducted using synthetic brine (80% of the brine being 3% sodium chloride brine and 20% of the brine being a hydrocarbon containing LVT-200 saturated with CO₂) as shown in Table 1. The corrosion rate was measured by Linear Polarization Resistance (LPR) techniques.

Data was collected for 2 hours before 10 ppm of the corrosion inhibitor composition (containing 20% of the reaction product corrosion inhibitor (chemically modified, maleated unsaturated fatty acid) versus 20% of the maleated tall oil fatty acid) was added, equating to 2 ppm of the active reaction product corrosion inhibitor with 0.4 ppm 2-mercaptoethanol being introduced into the test cell. Data was collected overnight for 21-hour test duration. The results are summarized in Table 6.

TABLE 6

| | | | | Candidate | 2- | Avg. | Corrosion | |
|---|---|---|---|---|---|---|---|---|
| | Candidate | | | Chemistry | Mercaptoethanol | Blank | Rate After | |
| | Chemistry | 2- | CI | Active | Active | Corrosion | 22 hour CI | |
| Tested | Active | Mercaptoethanol | Dosage | Injected | Injected | Rate | Injection | % |
| Formulations | (%) | (%) | (ppm) | (ppm) | (ppm) | (mpy) | (mpy) | Protection |
| Corrosion | 20 | 4 | 10 | 2 | 0.4 | 245.1 | 7.1 | 97.1 |
| Inhibitor | | | | | | | | |
| Maleated Tall | 20 | 4 | 10 | 2 | 0.4 | 256.8 | 30 | 88.3 |
| Oil Fatty | | | | | | | | |
| Acid | | | | | | | | |

As shown in Table 6, the evaluated chemically modified, maleated unsaturated fatty acid provides corrosion inhibition efficacy over the maleated tall oil fatty acid. Thus, the chemical modification of a maleated unsaturated fatty acid significantly improves the corrosion inhibition efficacy.

### Example 6

Additional comparison testing was conducted on the corrosion inhibitor of Example 1 (chemically modified, maleated unsaturated fatty acid) compared to conventional, unmodified maleated tall oil fatty acid. Partitioning tests were conducted of the chemically modified, maleated unsaturated fatty acid and maleated tall oil fatty acid to determine the partitioning coefficient via LC-MS (Liquid Chromatography-Mass Spectroscopy) analysis.

At room temperature, 50 mL of the synthetic brine of Table 1, 25 mL of aromatic 150, and 25 mL of LVT 200 were pipetted into a 125-mL separational funnel. 100 ppm of the chemically modified, maleated unsaturated fatty acid corrosion inhibitor or conventional, unmodified maleated tall oil fatty acid were dosed into the oil layer of the funnel. The cap was inserted into the funnel and the mixture was shaken vigorously for one minute and then set for an hour. After the hour rest, the bottom layer (brine layer) was drained and collected for LC-MS analysis. LC-MS analysis determines the amount of the corrosion inhibitor and maleated tall oil fatty acid that partitioned into the brine phase. The amount found in the brine phase was compared to the original amount introduced into the oil phase of the brine/oil solution (100 ppm) and a percentage amount is calculated. The percent amount of the chemically modified, maleated unsaturated fatty acid corrosion inhibitor and unmodified maleated tall oil fatty acid present in the brine phase is shown in Table 7.

TABLE 7

| | % Partitioning to |
|---|---|
| Tested Formulations | brine phase |
| Corrosion Inhibitor | 85.5 |
| Maleated Tall Oil Fatty | 4.9 |
| Acid | |

As shown in Table 7, the chemically modified, maleated unsaturated fatty acid corrosion inhibitor more effectively partitions to the brine phase over oil phase with over 85% of the total corrosion inhibitor included into the brine/oil solution. Comparatively, only 4.9% of the unmodified maleated tall oil fatty acid is partitioned to the brine phase. Thus, the chemically modified, maleated unsaturated fatty acid corrosion inhibitor demonstrated a significant improvement in water partitioning over conventional maleated fatty acids.

These results confirm the chemically modified, maleated unsaturated fatty acid or salt thereof provides an improved partitioning which is important for the corrosion inhibitor to be present in the water phase and reach the metal surface in need of corrosion inhibitor. In embodiments the corrosion inhibitors described herein provide improved partitioning between the oil, water and solid phases of fluid within a system or containment.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A corrosion-inhibiting composition comprising:
chemically modified, maleated unsaturated fatty acid or salt thereof, wherein the chemical modification is an amidation of the maleated unsaturated fatty acids using a monoamine, and at least one of a solvent, synergist, additional corrosion inhibitor, asphaltene inhibitor, paraffin inhibitor, scale inhibitor, emulsion breaker, or combinations thereof.

2. The composition of claim 1, wherein the monoamine is a polyether monoamine having the general structure: 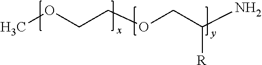
wherein R is H or CH₃, x and y are independently integers from about 1 to about 150.

3. The composition of claim 2, wherein the monoamine is a polyether monoamine having a molecular weight from about 200 to about 2000 g/mol.

4. The composition of claim 1, wherein the maleated unsaturated fatty acid is a maleated tall oil fatty acid having one or more of the following structures:

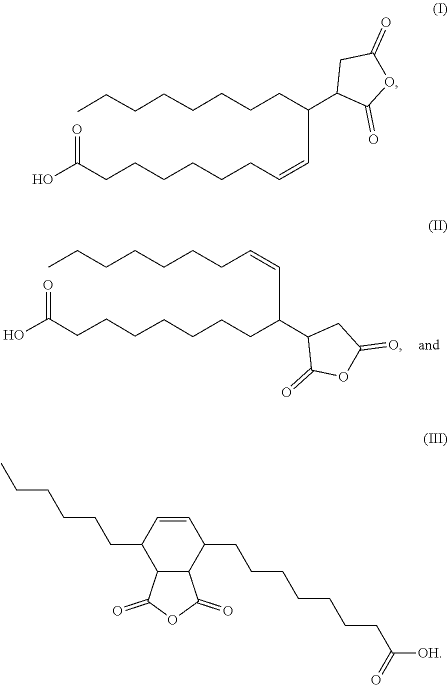 [SMILES: CCCCCCCCC(/C=C\CCCCCCC(=O)O)C1CC(=O)OC1=O ; CCCCCCC/C=C\C(CCCCCCCC(=O)O)C1CC(=O)OC1=O ; CCCCCCC1C=CC(CCCCCCCC(=O)O)C2C(=O)OC(=O)C12]

5. The composition of claim 1, wherein the chemically modified, maleated unsaturated fatty acid or salt thereof have one or more of the following general structures:

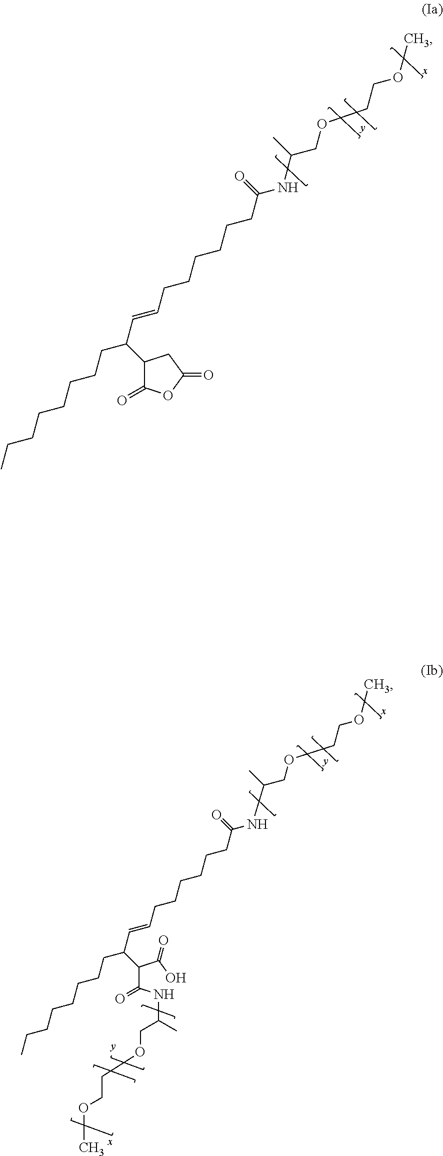

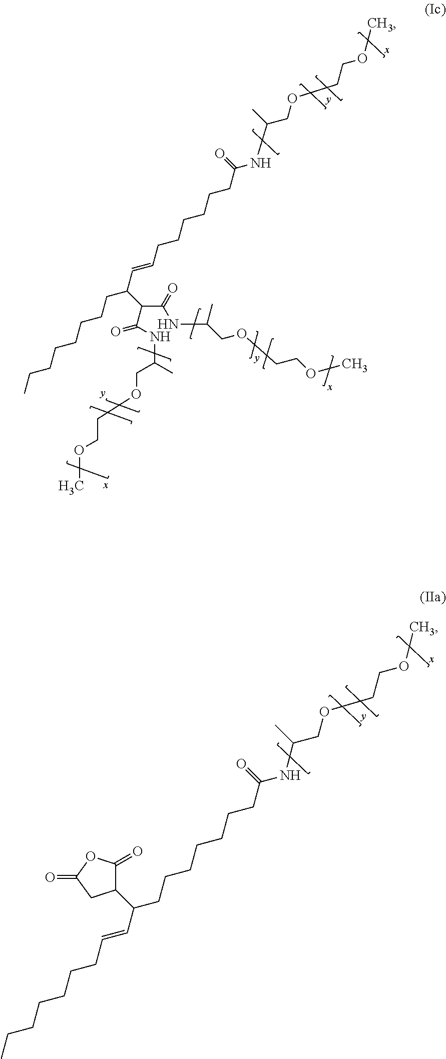

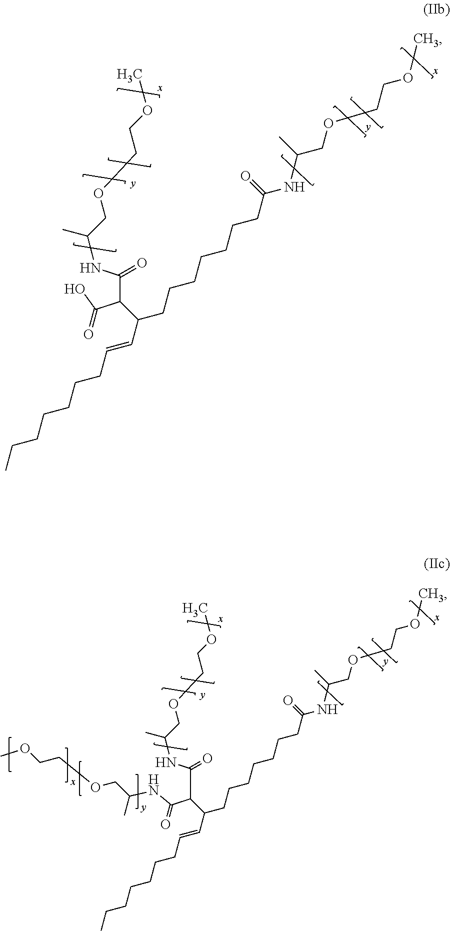

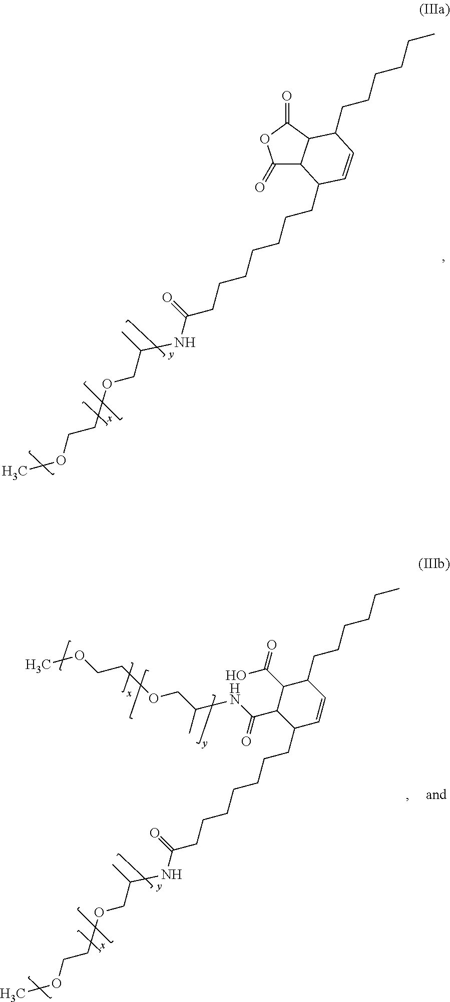

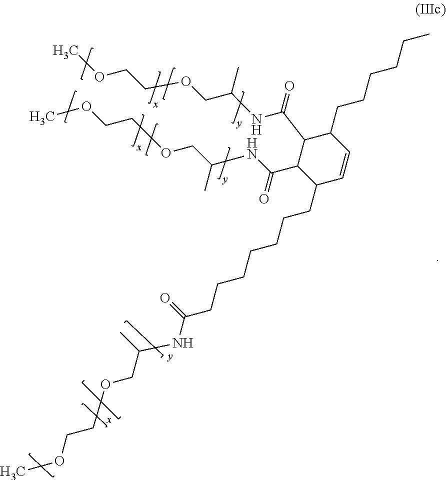

6. The composition of claim 1, wherein the chemically modified, maleated unsaturated fatty acid or salt thereof has a total amine value greater than zero mgKOH/g and/or an acid value less than 50 mgKOH/g.

7. The composition of claim 6, wherein the acid value is greater than the total amine value.

8. The composition of claim 5, wherein the chemically modified, maleated unsaturated fatty acid or salt thereof has one or more of the structures Ia, Ib, IIa, IIb, IIIa, and/or IIIb, or wherein the chemically modified, maleated unsaturated fatty acid or salt thereof has one or more of the structures Ib, IIb and/or IIIb.

9. The composition of claim 1, wherein the solvent comprises ethylene glycol monobutyl ether and/or aromatic solvents.

10. The composition of claim 1, wherein the corrosion inhibition composition further comprises at least one additional component selected from the group consisting of synergist, additional corrosion inhibitors, surfactants, polymers, pH modifiers, asphaltene inhibitors, paraffin inhibitors, scale inhibitors, metal complexing agents (chelants), emulsifiers, water clarifiers, dispersants, emulsion breakers and combinations thereof.

11. The composition of claim 1, wherein the chemically modified, maleated unsaturated fatty acid or salt thereof makes up from about 1 wt-% to about 50 wt-% of the composition, wherein the solvent(s) make up from about 40 wt-% to about 99 wt-% of the composition.

12. A method of making a chemically modified maleated unsaturated fatty acid or salt thereof comprising:
chemically modifying a maleated unsaturated fatty acid or salt thereof according to claim 1, produced by an amidation reaction of the maleated unsaturated fatty acids using a polyether monoamine.

13. The method of claim 12, wherein the amidation reaction temperature is between about 50° C. and about 200° C.

14. The method of claim 12, wherein the molar ratio of the polyether monoamine to the maleated unsaturated fatty acid is from about 0.1:1 to about 1:0.1.

15. A method of controlling corrosion on a surface comprising:
providing a corrosive inhibiting effective amount of a corrosion inhibition composition according to claim 1 into contact with a surface comprising metal in an oil-and-gas system, and wherein the contacting is added in a batch or continuous application, and reducing corrosion on the surface.

16. The method of claim 15, wherein the corrosive inhibiting effective amount of the composition is from about 1 ppm to about 5,000 ppm, based on the total volume of the system.

17. The method of claim 15, wherein the metal surface comprises steel.

18. The method of claim 17, wherein the surface is a containment used in the production, transportation, storage and/or separation of crude oil, natural gas or biofuel processes.

19. The method of claim 15, wherein the system comprises a hydrocarbon fluid or gas, produced water, or combination thereof.

20. A treated metal containment comprising:
a metal containment comprising a metal surface; and
a barrier or film substantially coating the metal surface with a corrosive inhibiting effective amount of the composition according to claim 1 comprising the chemically modified, maleated unsaturated fatty acids or salts thereof.

21. The treated metal containment of claim 20, wherein the corrosive inhibiting effective amount of the chemically modified, maleated unsaturated fatty acids and salts thereof is from about 1 ppm to about 5000 ppm, based on the total volume of the containment.

22. The treated metal containment of claim 20, wherein the metal surface comprises steel.

23. The treated metal containment of claim 20, wherein the surface is a containment used in the production, transportation, storage and/or separation of crude oil, natural gas or a biofuel process.
